(19) United States
(12) Patent Application Publication
(10) Pub. No.: US 2008/0220290 A1
(43) Pub. Date: Sep. 11, 2008

(54) Magnetic recording medium and manufacturing method for the same

(75) Inventors: Ken-ichi Itoh, Yamato (JP); Hideyuki Kikuchi, Higashine (JP); Hiroshi Nakao, Higashine (JP); Hirotaka Oshima, Higashine (JP); Takahiro Umada, Kawasaki (JP); Hideki Masuda, Tokyo (JP); Kazuyuki Nishio, Tokyo (JP); Mitsuo Takeuchi, Kawasaki (JP); Hiroaki Date, Kawasaki (JP)

Correspondence Address: GREER, BURNS & CRAIN, 300 S WACKER DR, 25TH FLOOR, CHICAGO, IL, 60606, US

(73) Assignees: Fujitsu Limited, Kawasaki-shi (JP); Kanagawa Academy of Science and Technology, Kawasaki-shi (JP)

(21) Appl. No.: 12/006,062

(22) Filed: Dec. 28, 2007

(30) Foreign Application Priority Data
Jan. 5, 2007 (JP) 2007-000566

(51) Int. Cl. G11B 5/65; B44C 1/22

(52) U.S. Cl. 428/836; 216/22

(57) ABSTRACT

To provide a magnetic recording medium manufacturing method capable of transferring a pattern that can serve as a source for forming anodized alumina-nanoholes with high precision and realizing high productivity, and a large-capacity magnetic recording medium capable of achieving high density recording. The method includes forming a metallic layer on a concavo-convex pattern formed on a surface of a mold; bonding a substrate using an adhesive to a surface of the metallic layer on the side opposite to the mold; separating the mold from the metallic layer; forming, through nanohole formation treatment, a porous layer in which a plurality of nanoholes are formed to orient in a direction substantially perpendicular to a substrate plane by using as a nanohole source a concavo-convex pattern which has been formed by transferring the concavo-convex pattern in the mold to the metallic layer; and charging a magnetic material inside the nanoholes.

### CROSS-REFERENCE TO RELATED APPLICATION

This application is based upon and claims the benefits of the priority from the prior Japanese Patent Application No. 2007-000566 filed on Jan. 5, 2007, the entire contents of which are incorporated herein by reference.

### BACKGROUND OF THE INVENTION

1. Field of the Invention

The present invention relates to a large-capacity magnetic recording medium which is suitably used for a hard disk drive widely used as an external storage device for a computer, a household video recording device and the like and which is capable of achieving high density recording, and to an effective low cost manufacturing method for manufacturing the recording medium.

2. Description of the Related Art

Recent technical innovation in the IT industry has promoted extensive research and development for large capacity, high-speed, low cost magnetic recording media. To realize such media it is inevitable to increase the recording density of the magnetic recording medium, and patterned magnetic recording media (patterned media) have been proposed in which the magnetic film in the magnetic recording medium is not formed as a continuous film but formed as a patterned film having dots, bars or pillars of the order of nanometers to thereby obtain a single domain structure rather than a complex domain.

In the above patterned media, a pattern of submicron order needs to be formed over the entire surface of the magnetic disk with high accuracy and at low costs. For example, a patterned medium prepared by filling nanoholes of anodized aluminum with magnetic metal is known to offer an ordered array of nanoholes by forming a pattern of concaves that serves as a nanohole source on a surface of an aluminum layer before it is anodized (see Japanese Patent Application Laid-Open (JP-A) No. 10-121292).

Further, the present inventors have accomplished forming a one-dimensional array of nanoholes along the circumferential of a magnetic disk by forming a pattern of groove rather than concave (see JP-A No. 2005-305634).

Methods of forming such patterns are of two types: direct write methods that form patterns in each magnetic disk, including EB writing method and various lithography techniques; and imprint methods in which a mold (also referred to as “stamper”) is fabricated from a lithography pattern followed by transfer of the pattern formed on the mold onto a disk. In terms of productively, the latter is more advantageous.

For the manufacture of patterned media using nanoholes described above, available imprint methods are imprint methods shown in FIGS. 14A and 14B.

The method shown in FIG. 14A is referred to as “hard imprint method,” in which a mold 110 having a submicron pattern is pressed against a surface of an aluminum layer 130 formed on a hard disk substrate 120 so as to transfer the pattern thereon (see JP-A No. 10-96808). In this method, however, a pressure of 4 ton/cm² is required to transfer, e.g., a 63 nm pitch-triangle lattice pattern onto a surface of the aluminum layer. As pattern lines become finer, a higher pressure is required, making it difficult to form the pattern on a large area and to ensure mold durability.

A method which is expected to solve such a problem inherent to the hard imprint method is a “soft imprint method” shown in FIG. 14B. In this method, a resin layer 140 is formed on a surface of the aluminum layer 130 formed on the hard disk substrate 120, and the mold 110 is pressed against the resin layer 140 to transfer the pattern, followed by etching to form the pattern on the aluminum layer 130. In this method, however, it is difficult to uniformly transfer the pattern on the entire surface of the aluminum layer. Further, in this case, the aluminum layer needs to be etched, with the pattern on the resin layer being intact. However, the resin layer generally has low etching resistance and, therefore, it is impossible to form concave portions having a depth enough to sufficiently serve as a nanohole source.

The hard imprint method and soft imprint method both have the following inherent problem. Each method conducts pattern transfer after deposition of the aluminum layer. When sputtering or vapor deposition is used for deposition, however, the crystal grain size increases as layer formation proceeds, thereby generating asperities over the surface of the aluminum layer to which a pattern is to be transferred, whereby accurate transfer of a nanoscale pattern is made difficult.

As a third method of forming the pattern in the anodized alumina-nanoholes, a method shown in FIGS. 14C and 14D is proposed (see JP-A No. 2005-76117 and Y. Matsui, K. Nishio, and H. Masuda, Small 2006. 2, No. 4, 522 to 525).

The method shown in FIG. 14C includes the steps of (a) regularly arranging fine particles 220 over a substrate 210, (b) depositing an aluminum (plate) 200 on the ordered array of fine particles 220 by means of physical film deposition method such as vapor deposition or sputtering, (c) separating the aluminum plate 200 from the substrate 210, and (d) separating the array of fine particles from the aluminum plate 200 for instance by particle dissolution, to produce regularly spaced concaves in the surface of the aluminum plate 200

The method shown in FIG. 14D includes the steps of (a) preparing a mold 310 having a surface structure 310A with regularly spaced concaves (convexes) which can be formed using a fine processing technology such as an electron beam lithography or photolithography, (b) depositing an aluminum 320 over the surface structure 310A by vapor deposition or sputtering followed by transferring of the surface structure 310A onto a surface of the aluminum 320, and (c) separating the mold 310 so that a surface structure 320A having the same pattern as the surface structure 310A is formed on the surface of the aluminum 320.

With the methods shown in FIGS. 14C and 14D, a pattern is transferred onto an aluminum film at an initial state of film deposition, and thus it is possible to avoid the above problem associated with the growth of particles in the film during deposition. These methods, however, can form an aluminum film with a thickness of only several microns, and therefore cannot be applied to manufacture of magnetic disks.

Accordingly, the current situation is that a manufacturing method for a large capacity and high density recording-enabled magnetic recording medium, capable of solving abovementioned problem inherent to the imprint method, achieving high pattern transfer accuracy, transferring a pattern that can serve as a source for forming anodized alumina-nanoholes with high precision, and realizing high productivity, and techniques related to the manufacturing method have not yet been provided.

An object of the present invention is to solve the above problem inherent to the related arts and to provide a low cost manufacturing method for a magnetic recording medium, which method is capable of transferring a pattern that can serve as a source for anodized alumina-nanoholes with high precision and realizing high productivity, and a large-capacity magnetic recording medium which is suitably used in a hard disk drive widely used as an external storage device for a computer, a household video recording device and the like and which is capable of achieving high density recording.

### BRIEF SUMMARY OF THE INVENTION

The means to solve the foregoing problems are described in attached claims.

More specifically, the method of the present invention for manufacturing a magnetic recording medium includes: forming a metallic layer on a concavo-convex pattern formed on a surface of a mold; bonding a substrate using an adhesive to a surface of the metallic layer on the side opposite to the mold; separating the mold from the metallic layer; forming, through nanohole formation treatment, a porous layer in which a plurality of nanoholes are formed to orient in a direction substantially perpendicular to a substrate plane by using as a nanohole source a concavo-convex pattern which has been formed by transferring the concavo-convex pattern in the mold to the metallic layer; and charging a magnetic material inside the nanoholes.

In the metallic layer formation step a metallic layer is deposited onto the concavo-convex pattern of a mold. In the substrate bonding step a substrate is bonded to a surface of the deposited metallic layer on the side opposite to the mold by use of an adhesive. Thereafter, in the mold separation step, the mold is separated from the metallic layer. In this way the concavo-convex pattern of the mold is transferred to the metallic layer with high accuracy, forming a high-resolution concavo-convex pattern on a surface of the metallic layer. In the subsequent porous film formation step, nanohole formation treatment is conducted to form a porous layer in which a plurality of nanoholes is formed that are oriented in a direction substantially perpendicular to a surface plane at positions corresponding to the concavo-convex pattern. In the magnetic material charging step the nanoholes are filled with magnetic material. In this way a magnetic recording medium is manufactured efficiently and inexpensively that is capable of high-density recording for large storage capacity.

The magnetic recording medium of the present invention includes: a substrate; an adhesive layer over the substrate; and a porous layer over the adhesive layer, wherein the porous layer comprises a plurality of nanoholes that are oriented in a direction substantially perpendicular to a plane of the substrate, and wherein the nanoholes comprise therein a magnetic material.

The magnetic recording medium of the present invention has a porous film with a plurality of nanoholes formed therein over a substrate, with an adhesive layer interposed between the porous film and the substrate, wherein the nanoholes are generated using as a nanohole source a concavo-convex pattern transferred with high accuracy from a mold, and are filled with magnetic material as well. Accordingly, the magnetic recording medium is capable of high-density recording for large storage capacity and is of very high quality, and thus is suitable for instance for hard disk devices used as external storage devices for computers and house-hold video recorders.

### BRIEF DESCRIPTION OF THE SEVERAL VIEWS OF THE DRAWINGS

FIG. 1A is a photograph showing a state of a surface of a metallic layer after a mold is separated from the metallic layer using a knife edge.

FIG. 1B is a view schematically showing a state of a surface of a metallic layer after a mold is separated from the metallic layer using a knife edge.

FIG. 2A is a photograph showing a state of a surface of a metallic layer after a mold is separated from the metallic layer using a push-up mechanism.

FIG. 2B schematically shows a state of a surface of a metallic layer after a mold is separated from the metallic layer using a push-up mechanism.

FIG. 3A schematically shows an example of a push-up mechanism used in a mold separation step in a magnetic recording medium manufacturing method according to the present invention.

FIG. 3B schematically shows an example of a mold separation step using the push-up mechanism shown in FIG. 3A.

FIG. 4A schematically shows an example of a mold used in a magnetic recording medium manufacturing method according to the present invention.

FIG. 4B schematically shows an example of a metallic layer formation step in the magnetic recording medium manufacturing method according to the present invention.

FIG. 4C schematically shows an example of a substrate bonding step in the magnetic recording medium manufacturing method according to the present invention.

FIG. 4D schematically shows an example of a mold separation step in the magnetic recording medium manufacturing method according to the present invention.

FIG. 5 schematically shows an example of a bonded article composed of a metallic layer for A-side and substrate which is produced through the metallic layer formation step, substrate bonding step, and mold separation step when the magnetic recording medium manufacturing method according to the present invention is used to manufacture a double-sided magnetic recording medium.

FIG. 6A schematically shows an example of a B-side mold used when the magnetic recording medium manufacturing method according to the present invention is used to manufacture a double-sided magnetic recording medium.

FIG. 6B schematically shows an example of the metallic layer formation step carried out using the B-side mold shown in FIG. 6A.

FIG. 7A schematically shows an example of the substrate bonding step (bonding between B-side metallic layer and substrate) when the magnetic recording medium manufacturing method according to the present invention is used to manufacture a double-sided magnetic recording medium.

FIG. 7B schematically shows an example of the mold separation step (separation between B-side mold and metallic layer) when the magnetic recording medium manufacturing method according to the present invention is used to manufacture a double-sided magnetic recording medium.

FIG. 8A is a first schematic step view in the case where the metallic layer formation step, substrate bonding step, and mold separation step are collectively applied to a plurality of substrates.

FIG. 8B is a second schematic step view in the case where the metallic layer formation step, substrate bonding step, and mold separation step are collectively applied to a plurality of substrates.

FIG. 8C is a third schematic step view in the case where the metallic layer formation step, substrate bonding step, and mold separation step are collectively applied to a plurality of substrates.

FIG. 8D is a fourth schematic step view in the case where the metallic layer formation step, substrate bonding step, and mold separation step are collectively applied to a plurality of substrates.

FIG. 8E schematically shows a bonded article composed of a plurality of metallic layers and substrates which is obtained in the case where the metallic layer formation step, substrate bonding step, and mold separation step are collectively applied to a plurality of substrates.

FIG. 9A schematically shows an example of a porous layer formation step in the magnetic recording medium manufacturing method according to the present invention.

FIG. 9B schematically shows an example of a magnetic material charging step in the magnetic recording medium manufacturing method according to the present invention.

FIG. 9C schematically shows an example of a double-sided magnetic recording medium as a magnetic recording medium according to the present invention.

FIG. 10 schematically shows a prototype of a separation tool used in an experiment of transfer of a pattern formed on a mold to an aluminum layer and in the manufacturing of the magnetic recording medium.

FIG. 11A is a photograph showing an arrangement of nanoholes (arranged in one row) obtained in the case where anodizing has been carried out using a concavo-convex pattern having a land/groove pitch of 90 nm as a source of nanoholes.

FIG. 11B is a photograph showing an arrangement (arranged in two rows) of nanoholes obtained in the case where anodizing has been carried out using a concavo-convex pattern having a land/groove pitch of 150 nm as a source of nanoholes.

FIG. 12 is a photograph showing a piezo output waveform obtained in the case where a piezo head floated from a magnetic disk sample for characteristic evaluation manufactured by the magnetic recording medium manufacturing method according to the present invention.

FIG. 13 is a graph showing a reproduction waveform of a magnetic signal obtained in the case where recording and reproduction of the magnetic signal are performed using the disk sample for characteristic evaluation manufactured by the magnetic recording medium manufacturing method according to the present invention.

FIG. 14A schematically shows a conventional hard imprint method.

FIG. 14B schematically shows a conventional soft imprint method.

FIG. 14C shows an example of a pattern formation method in anodized alumina-nanoholes.

FIG. 14D shows another example of a pattern formation method in anodized alumina-nanoholes.

### DETAILED DESCRIPTION OF THE INVENTION

### (Manufacturing Method of Magnetic Recording Medium)

A magnetic recording medium manufacturing method according to the present invention includes at least a metallic layer formation step, a substrate bonding step, a mold separation step, a porous layer formation step, and a magnetic material charging step and preferably further includes a soft magnetic underlayer formation step and a polishing step. Further, the method includes, if necessary, an electrode layer formation step, a protective layer formation step, and the like.

### <Metallic Layer Formation Step>

The metallic layer formation step is a step in which a metallic layer is formed on a concavo-convex pattern of a mold.

### —Mold—

The mold is not especially limited as long as it has a concavo-convex pattern on the surface thereof and materials thereof can appropriately be selected according to the purpose; preferably used materials include: silicon, silicon oxide film and a combination thereof in view of the fact that they are most widely used as materials for manufacturing fine structures in the semiconductor field; silicon carbide for its high durability in continuous use; and Ni which is used in the forming of optical disks. The mold can be used a plurality of times.

The concavo-convex pattern in the mold is preferably one corresponding to a pattern of arrangement of formed nanoholes, that is, one having land portions (convex portions) and groove portions (concave portions) that respectively correspond to the concave portions and convex portions that may serve as a nanohole source.

The shape of the land portion is not especially limited and can appropriately be selected according to the purpose but is preferably a line shape and, therefore, the concavo-convex pattern in the mold is preferably a line pattern in which the land portions and groove portions are alternately arranged.

When the concavo-convex pattern in the mold is transferred to the metallic layer, a concavo-convex pattern (or nanohole source) is formed in which concave lines (concave portions) and convex lines (convex portions) are alternately arranged. After that, when nanohole formation treatment (e.g., anodizing) is carried out, nanoholes can be formed at constant intervals only in the concave portions, whereby a porous layer on which the nanoholes are linearly arranged is formed.

The cross-sectional shape of the land portion (convex line) in the direction perpendicular to the longitudinal direction thereof is not especially limited and can appropriately be selected according to the purpose. Examples of the cross-sectional shape of the land portion include a quadrangle, V-shape, and semicircular shape.

The land portions (convex lines) are preferably arranged in a concentric or helical manner. In the case where a recording medium is used for a hard disk, the land portions are preferably arranged in a concentric manner in terms of accessibility; while in the case where a recording medium is used for a video disk, the land portions are preferably arranged in a helical manner because of advantage in continuous reproduction. In the case where the land portions are arranged in a concentric or helical manner, it is possible to arrange nanoholes to be formed in a concentric or helical manner correspondingly.

The height of the land portion in the concavo-convex pattern is not especially limited and can appropriately be selected according to the purpose but is preferably 5 nm or more and, more preferably, is 10 nm to 100 nm.

When the height of the land portion is less than 5 nm, fixation of the positions of nanohole sources are likely to be poor, which may in turn result in less regular arrangement of resulting nanoholes.

### —Metallic Layer—

The material for the metallic layer can be any suitable material selected according to the purpose, such as elementary metals, as well as oxides, nitrides and alloys of such metals. Alumina (aluminum oxide) and aluminum can be taken as examples. Among them, especially preferred is aluminum.

The metallic layer can be formed using a known method. For example, sputtering or vapor deposition is preferably used.

Further, the metallic layer can be formed under any suitable condition according to the purpose.

In the case of sputtering, a sputtering target made of any of the metallic materials can be employed. The sputtering target used herein preferably has a high purity, and when the metallic material is aluminum, it preferably has a purity of 99.990% or more.

The metallic layer formation step preferably includes, prior to deposition of the metallic layer, applying a releasing agent on the concavo-convex pattern of the mold. This makes it easy to remove the mold from the metallic layer in the mold separation step to be described later.

The releasing agent is not particularly limited and may be suitably selected from various surface treating agents according to the purpose. Among them, fluorine-containing surface treating agents and silane coupling agents are preferably used.

Examples of the fluorine containing surface treating agent include, for example, “Novec EGC-1720” manufactured by Sumitomo 3M Ltd. Examples of the silane coupling agents include, for example, “Optool DSX” manufactured by Daikin Industries Ltd.

With the above steps, the metallic layer is formed on the concavo-convex pattern in the mold.

### <Soft Magnetic Underlayer Formation Step>

The soft magnetic underlayer formation step is a step in which a soft magnetic underlayer is formed on the metallic layer.

The soft magnetic underlayer can be formed using a known method. For example, formation of the soft magnetic underlayer may be conducted by means of vacuum film deposition such as sputtering or vapor deposition, electrodeposition, or electroless deposition.

With the soft magnetic underlayer formation step, the soft magnetic underlayer having a desired thickness is formed on the metallic layer.

If necessary, a metallic layer may be formed on the soft magnetic underlayer for the purpose of ensuring mechanical strength.

### <Electrode Layer Formation Step>

The electrode layer formation step is a step in which an electrode layer is formed between the metallic layer and soft magnetic underlayer.

The electrode layer can be formed using a known method. For example, sputtering or vapor deposition is preferably used. Further, the electrode layer can be formed under any suitable condition according to the purpose.

The electrode layer formed by the electrode layer formation step serves as an electrode in the formation of at least one of a soft magnetic layer, nonmagnetic layer and ferromagnetic layer by electrodeposition.

### <Substrate Bonding Step>

The substrate boding step is a step in which a substrate is bonded by adhesive to the surface of the metallic layer on the side opposite to the mold (in the case where the soft magnetic layer is formed or both the soft magnetic layer and metallic layer for mechanical strength are formed on the metallic layer, the substrate is bonded to the outermost surface of these layers on the side opposite to the mold).

### —Substrate—

The substrate can have any suitable shape, structure and size and be made of any suitable material according to the purpose. The substrate preferably has a disk shape when the magnetic recording medium is a magnetic disk such as hard disk. It can have a single layer structure or a multilayer structure. Examples of the material include glass, aluminum, silicon, and quartz.

Preferable examples of the substrate include a glass substrate, aluminum substrate, and silicon substrate as a magnetic disk substrate.

The substrate can be suitably prepared or is available as a commercial product.

### —Adhesive—

The adhesive is not particularly limited and may be suitably selected according to the purpose, but preferably used adhesives include epoxy resin-based adhesives for their high bonding strength; low-hardening contraction type adhesives for their low hardening contraction ratios; modified silicone resin-based adhesives in view of the fact that they exhibit a high capability of bonding together materials having different thermal expansion coefficients; and cyanoacrylate-based adhesives in view of the fact that they set in a shot time. These adhesives can be used singly or in combination.

The epoxy resin adhesive is generally a two-component type. Preferable examples thereof include “Bond—white for repairing enameled products” and “Bond E-set” manufactured by Konishi Co., Ltd., “EP007” manufactured by Cemedine Co., Ltd., and “EPICLON EXA-4850 series” manufactured by Dainippon Ink & Chemicals Incorporated.

As the low-hardening contraction type adhesive, “EPICLON EXA-4850-150” manufactured by Dainippon Ink & Chemicals Incorporated. using TETA (TriEhylene TetraAmine) as hardening agent is preferable because of its flexibility, rigidity, and low hardening contraction ratio of 0.6%.

Preferable examples of the modified silicone resin adhesives include “Bond MOS7” manufactured by Konishi Co., Ltd., and “PM series” manufactured by Cemedine Co., Ltd.

A preferable example of the cyanoacrylate adhesive is “Bond Aron Alpha—impact resistance—for professional use” manufactured by Konishi Co., Ltd.

With the above steps, the substrate is bonded by the adhesive to the surface of the metallic layer on the side opposite to the mold. As a result, the metallic layer (in the case where the soft magnetic layer is formed or both the soft magnetic layer and metallic layer for mechanical strength are formed on the metallic layer, the metallic layer includes these layers) and substrate are laminated in this order on the concavo-convex pattern in the mold.

### <Mold Separation Step>

The mold separation step is a step in which the mold is separated from the metallic layer after the substrate bonding step.

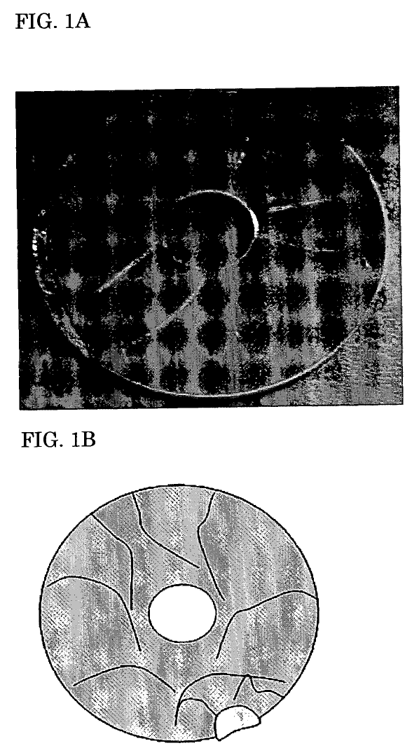

The method of separating the mold from the metallic layer is not especially limited and any suitable method can be employed according to the purpose; for example, a separating method of making a cut in the end of the interface between the mold and metallic layer with a knife edge is used. However, a Ni stamper is generally used as the mold and, therefore, it is actually very difficult to separate nickel having a submicron structure from aluminum (the metallic layer) at their interface. That is, with the separation method using a knife edge, wrinkles may occur over the surface of the aluminum layer (metallic layer) due to non-uniform stress applied upon separation, as shown in FIGS. 1A and 1B. For example, JP-A No. 2005-76117 discloses in its Example the separation at the interface of an array of particles. Although it is speculated that separation at the particle array interface is easy, separation of the mold from the metallic layer is considered to be very difficult.

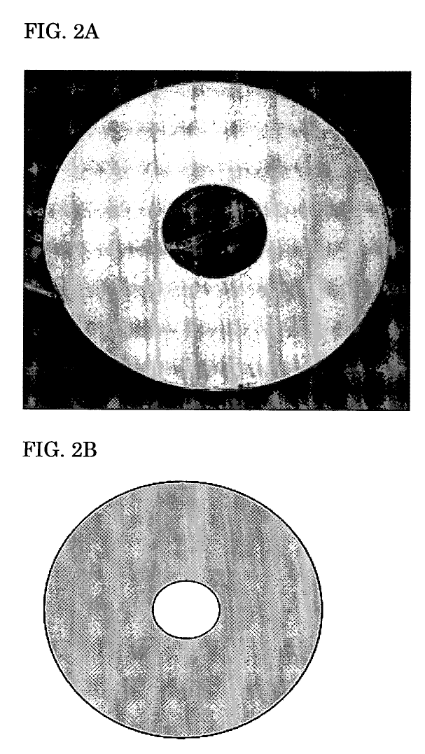

Thus, the mold separation step is preferably carried out using a push-up mechanism. More specifically, the push-up mechanism is used to push up the inner peripheral edge of the substrate having an opening in its center from the mold side. In this case, as shown in FIGS. 2A and 2B, the mold can easily be separated from the metallic layer without occurrence of any wrinkles.

### —Push-Up Mechanism—

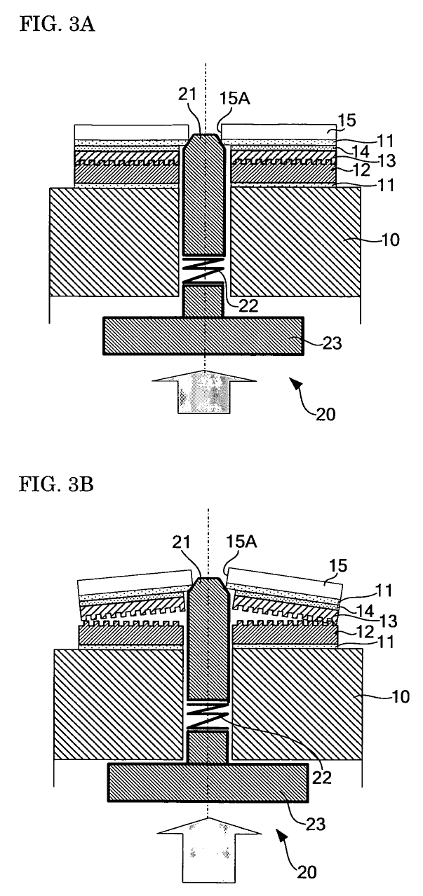

The push-up mechanism can have any suitable configuration as long as it has a function of pushing up the substrate (the magnetic disk substrate) having an opening in its center at its inner peripheral edge from the mold to thereby separate the mold from the metallic layer. For example, as shown in FIG. 3A, a push-up mechanism 20 preferably includes a push-up pin 21 for contacting an inner peripheral edge 15A of a substrate 15 (magnetic disk substrate) having an opening to push up the substrate 15, a spring 22, and a pressure pin 23 for pushing up the push-up pin 21. In this configuration, the push-up pin 21 is biased toward the pressure pin 23 by the spring 22 so as to move upward. As shown in FIG. 3B, when a pressure is manually or automatically applied to the pressure pin 23, the push-up pin 21 biased toward the pressure pin 23 by the spring 22 is pushed up to move upward and then comes into contact with the inner peripheral edge 15A of the substrate (magnetic disk substrate) 15, whereby the substrate 15 is pushed up from a mold 12 side. As a result, a metallic layer 13 is separated from the mold 12.

As the separation method using the push-up mechanism, there has been proposed, in a duplication technique of an optical disk using a photopolymer method, a method of separating a glass substrate that is bonded to a stamper (mold) with a photopolymer (see Re-published Patent WO2003/083854). This method aims at separating the photopolymer from the stamper at their interface, but differs from the mold separation step in the magnetic recording medium manufacturing method according to the present invention, and thus this patent literature fails to disclose separation of the mold from the metallic layer at their interface (metal-metal interface).

Hereinafter, an example of a method of manufacturing a bonded article composed of the substrate and metallic layer (aluminum layer) through the above metallic layer formation step, substrate bonding step, and mold separation step will be described with reference to the drawings.

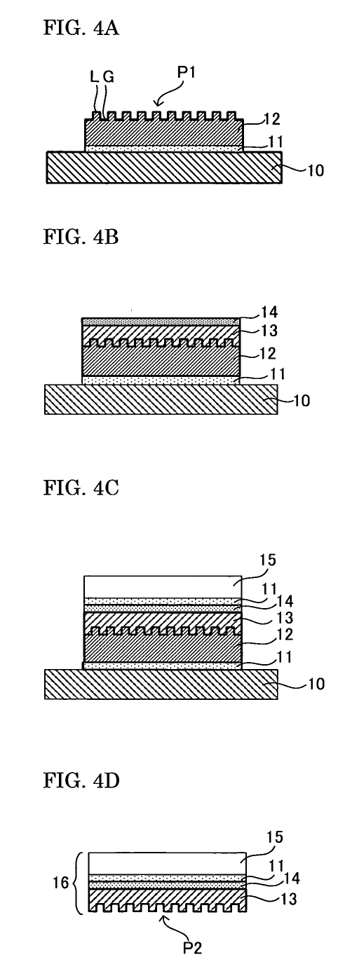

As shown in FIG. 4, a Ni mold 12 is bonded and fixed to a base 10 made of SUS by adhesive 11. The mold 12 has on its surface a linear concavo-convex pattern P1 in which land portions L and groove portions G are alternately arranged.

Subsequently, a unillustrated releasing agent is applied over the concavo-convex pattern P1 in the mold 12 and, as shown in FIG. 4B, a metallic layer (aluminum layer) 13 is deposited by sputtering of an aluminum target. In order to facilitate writing operation by means of a vertical magnetic head, a soft magnetic underlayer 14 (and a unillustrated metallic layer for increased mechanical strength) is deposited on the aluminum layer 13 (metallic layer formation step). In this state, as shown in FIG. 4C, an adhesive 11 is further applied to bond a substrate (e.g., a magnetic disk substrate) 15 to the resultant structure (substrate bonding step).

Subsequently, when the mold 12 is separated from the aluminum layer 13 as shown in FIG. 4D, a bonded article 16 composed of the substrate 15, aluminum layer 13, and soft magnetic underlayer 14 (and further unillustrated metallic layer for increased mechanical strength) is obtained (mold separation step). Further, at this time, the concavo-convex pattern P1 in the mold 12 is transferred on the surface of the aluminum layer 13 with accuracy, whereby a concavo-convex pattern P2 that can serve as a nanohole source is formed.

Further, after obtaining the bonded article composed of the substrate and the metallic layer having on its surface the concavo-convex pattern (i.e., after the mold separation step and before the porous layer formation step to be described later) through the above steps, the metallic layer that has been formed on the mold by the metallic layer formation step may be bonded to the surface of the substrate on the side opposite to the bonding surface to the metallic layer, followed by separation of the mold from the metallic layer. In this case, both the front and back sides of the substrate become available, whereby a double-sided recordable magnetic disk can be manufactured.

Hereinafter, a procedure of the metallic layer formation step, substrate bonding step, and mold separation step in the case where the two sides of the substrate are made available will be described with reference to the drawings.

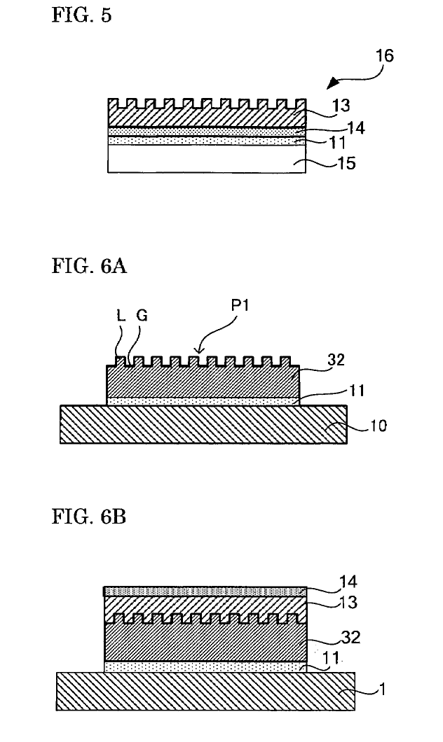

First, the mold 12 for A-side is used to produce the bonded article 16 composed of the substrate 15, aluminum layer 13, and soft magnetic underlayer 14 (and further a unillustrated metallic layer for increased mechanical strength) shown in FIG. 5 through the metallic layer formation step, substrate bonding step, and mold separation step shown in FIGS. 4A to 4D. The substrate 15 is firmly fixed to the metallic layer on the soft magnetic underlayer 14 with the adhesive 11 (through the adhesive layer 11).

Meanwhile, a mold for B-side is used to previously produce a structure in which a metallic layer has been formed on the mold for B-side through the metallic layer formation step. More specifically, as shown in FIG. 6A, a mold 32 for B-side is bonded and fixed by the adhesive 11 to the base 10 made of SUS. The mold 32 for B-side has, on its surface, a linear concavo-convex pattern P1 in which the land portions L and groove portions G are alternately arranged. Subsequently, after a unillustrated releasing agent is applied over the concavo-convex pattern P1 in the mold 32 for B-side, a metallic layer (aluminum layer) 13 is formed by sputtering of an aluminum target as shown in FIG. 6B. Further, in order to facilitate writing operation by means of a vertical magnetic head, a soft magnetic underlayer 14 (and further a unillustrated metallic layer for increased mechanical strength) is formed on the aluminum layer 13 (metallic layer formation step).

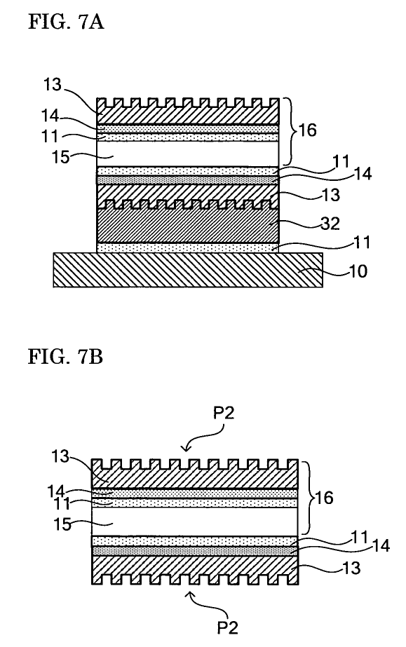

Then, the surface of the substrate 15 of the bonded article shown in FIG. 5 on the side opposite to the bonding surface to the aluminum layer 13 is bonded to the outermost layer of the soft magnetic underlayer 14 (and further a unillustrated metallic layer for increased mechanical strength) formed on the aluminum layer 13 which has previously been formed on the mold 32 for B-side (substrate bonding step, see FIG. 7A).

Subsequently, when the mold 32 for B-side is separated from the aluminum layer 13 formed on the mold 32 for B-side, the concavo-convex pattern P1 in the mold 32 for B-side is transferred with accuracy to the surface of the aluminum layer 13, whereby a concavo-convex pattern P2 that can serve as a nanohole source is formed (mold separation step, see FIG. 7B).

With the above steps, the aluminum layers 13 each having the concavo-convex pattern P2 are formed on both the front and back sides of the substrate 15. After the porous layer formation step and magnetic material charging step are carried out using the obtained structure, a double-sided recordable magnetic disk can be obtained.

In both the case of a single-sided structure and a double-sided structure, the metallic layer formation step, substrate bonding step, and mold separation step are preferably carried out for a plurality of substrates in a collective manner. In this case, it is possible to obtain a plurality of bonded articles each composed of the substrate and metallic layer at the same time, thereby increasing productivity.

Hereinafter, a procedure of the collective processing in the case where a single-sided structure is obtained will be described with reference to the drawings.

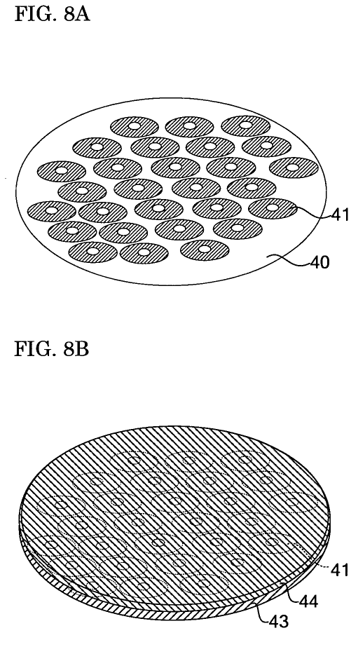

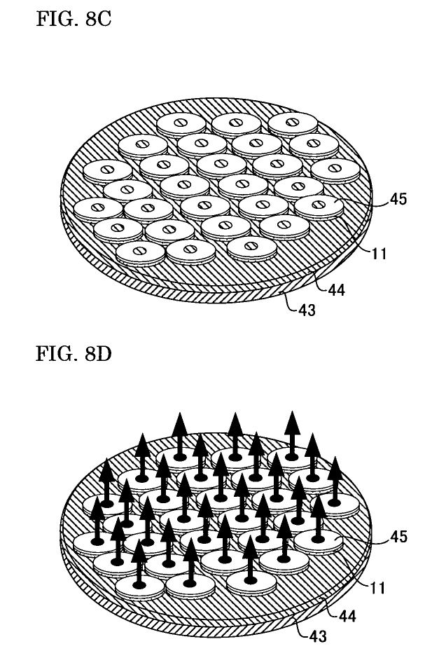

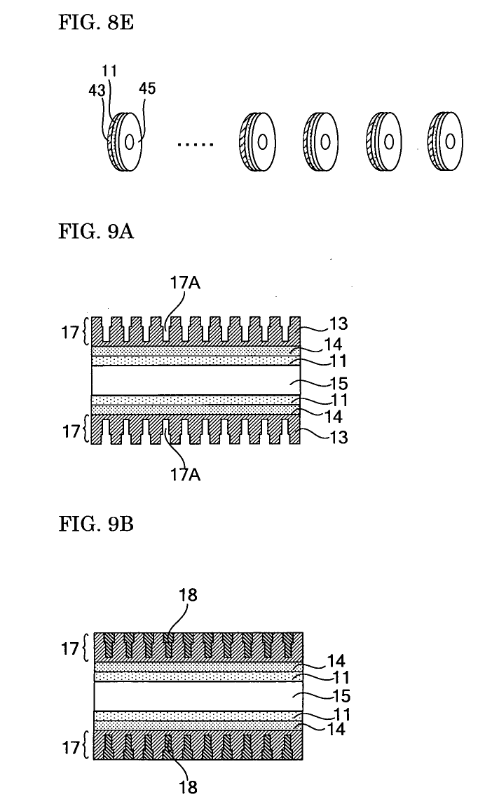

First, as shown in FIG. 8A, a plurality of patterned molds 41 produced by nickel electrocasting are bonded to a base 40. After that, as shown in FIG. 8B, an aluminum layer 43 and soft magnetic underlayer 44 are collectively formed on the patterned mold 41 (metallic layer formation step). Subsequently, as shown in FIG. 8C, substrates 45 are bonded and fixed using the adhesive 11 to the soft magnetic underlayer 11 (substrate bonding step) and, as shown in FIG. 8D, the push-up mechanism is used to collectively separate the patterned molds 41 from the aluminum layer 43 (mold separation step). As a result, as shown in FIG. 8E, a plurality of bonded articles composed of the substrate 45 and aluminum layer 43 (and soft magnetic underlayer 44) are obtained at the same time, thereby increasing throughput.

### <Porous Layer Formation Step>

The porous layer formation step is a step in which a porous layer is formed by performing nanohole formation treatment. The porous layer includes a plurality of nanoholes that are oriented in a direction substantially perpendicular to a plane of the substrate and that are formed by using as a nanohole source the concavo-convex pattern formed on the metallic layer through the transfer processing of the concavo-convex pattern in the mold.

The nanohole forming treatment can be any suitable treatment according to the purpose; examples include anodizing and etching. Among them, anodizing is particularly preferred since it can form a plurality of uniform nanoholes in the metallic layer at substantially equal intervals in a direction substantially perpendicular to a plane of the substrate.

The anodizing can be carried out by electrolyzing and etching the metallic layer in an aqueous solution of sulfuric acid, phosphoric acid or oxalic acid using an electrode contacting the metallic layer as an anode. The soft magnetic underlayer or the electrode layer can be used as the electrode.

The anodizing can be carried out at any suitable voltage but preferably at such a voltage satisfying the following relationship: interval (pitch) between adjacent rows of nanoholes (nm)/A (nm/V), (wherein A=1.0 to 4.0).

When the anodizing is carried out at a voltage satisfying the above equation, the nanoholes are advantageously arranged in the rows of concave portions in the concavo-convex pattern which has been formed through the transfer processing of the concavo-convex pattern in the mold.

When the substrate has a disk-shape, the nanoholes (fine pores) formed by the above nanohole formation treatment are arranged so as to extend in a direction substantially perpendicular to a free surface (plane) of the disk-shaped substrate.

The nanoholes may be through holes penetrating the nanohole structure or may be pits or convex portions not penetrating the porous layer. The nanoholes are preferably through holes penetrating the porous layer when the porous layer is used in the magnetic recording medium.

The nanoholes can be arranged in any suitable arrangement according to the purpose, bur are preferably arranged either a concentric manner or a helical manner when the nanohole structure is used in the magnetic recording medium such as a hard disk or video disk. In particular, they are preferably arranged in a concentric manner in the use for hard disks in view of accessibility, and are preferably arranged in a helical manner in the use for video disks for advantage in continuous reproduction.

In the case where the nanohole structure is used in the magnetic recording medium such as a hard disk, the nanoholes in adjacent nanohole rows are preferably arranged in a radial direction. The resulting magnetic recording medium is capable of high density, high speed recording without increasing a write current of the magnetic head, exhibits excellent and uniform properties such as overwrite properties, avoids crosstalk and crosswrite and is of very high quality.

The nanoholes can have openings with any suitable diameter according to the purpose. When the nanohole structure is used in the magnetic recording medium such as a hard disk, the diameter of opening is preferably such that the ferromagnetic layer becomes a single domain structure and is preferably 100 nm or less, more preferably 30 nm or less for realizing high density recording, and even more preferably 5 nm to 20 nm.

If the nanoholes have openings with a diameter exceeding 100 nm, in a magnetic recording medium, it results in failure to achieve a single domain structure in the magnetic recording medium, which is achieved by utilizing the above porous layer.

The nanoholes can have any suitable aspect ratio, i.e., the ratio of the depth to the diameter of opening. A high aspect ratio is preferable for higher anisotropy in dimensions and for higher coercive force of the magnetic recording medium. When the porous layer is used in a magnetic recording medium such as a hard disk, the aspect ratio is preferably 2 or more and more preferably 3 to 15.

An aspect ratio of less than 2 may invite insufficient coercive force of the magnetic recording medium.

The porous layer can have any suitable thickness according to the purpose. When the porous layer is used in the magnetic recording medium, the thickness is preferably 500 nm or less, more preferably 300 nm or less and even more preferably 20 nm to 200 nm.

If the porous layer having a thickness exceeding 500 nm is used in the magnetic recording medium, high-density information recording may not be achieved even if the magnetic recording medium further includes the soft magnetic underlayer. Thus, the porous layer must be polished to reduce its thickness and this requires time and costs, leading to poor quality.

The conditions the type, concentration, and temperature of an electrolyte and the time period for anodizing are not specifically limited and can be selected according to the number, size and aspect ratio of the target nanoholes. For example, the electrolyte is preferably a diluted phosphoric acid solution at intervals (pitches) of adjacent rows of nanoholes of 150 nm to 500 nm, is preferably a diluted oxalic acid solution at pitches of 80 nm to 200 nm, and is preferably a diluted sulfuric acid solution at a pitch of 10 nm to 150 nm. In any case, the aspect ratio of the nanoholes can be controlled by immersing the anodized metallic layer in, for example, a phosphoric acid solution to thereby increase the diameter of the nanoholes such as alumina pores.

When the porous layer formation step is carried out by the anodizing, a plurality of nanoholes can be formed in the metallic layer. However, a barrier layer may be formed at the bottom of the nanoholes in some cases. The barrier layer can be easily separated according to a known etching procedure using a known etchant such as phosphoric acid. Thus, a plurality of the nanoholes can be formed in the metallic layer so as to extend in a direction substantially perpendicular to the substrate surface and to expose the soft magnetic underlayer or the substrate from the bottom thereof.

The porous layer formation step forms the porous layer on or above the substrate or the soft magnetic underlayer.

### <Magnetic Material Charging Step>

The magnetic material charging step is a step in which a magnetic material is charged into the nanoholes formed in the porous layer.

The magnetic material charging step includes at least a ferromagnetic layer formation step for charging the ferromagnetic material into the nanoholes. The magnetic material charging step may include, if necessary, a soft magnetic layer formation step for charging the soft magnetic material into the nanoholes and a nonmagnetic layer formation step for forming a nonmagnetic layer (interlayer) between the ferromagnetic layer and soft magnetic layer.

### —Ferromagnetic Layer Formation Step—

The ferromagnetic layer formation step is a step in which a ferromagnetic layer is formed inside the nanoholes (or on or above the soft magnetic layer or the nonmagnetic layer, if formed in the nanoholes).

The ferromagnetic layer can be formed, for example, by depositing or charging the material for the ferromagnetic layer such as Fe, Co, Ni, FeCo, FeNi, CoNi, CoNiP, FePt, CoPt, or NiPt, inside the nanoholes typically by electrodeposition.

The electrodeposition can be carried out according to any suitable procedure under any suitable conditions according to the purpose. It is preferably carried out by applying a voltage to a solution containing one or more of the materials for the ferromagnetic layer using the soft magnetic underlayer or the electrode layer (seed layer) as an electrode and precipitating or depositing the material inside the nanoholes.

As a result of the ferromagnetic layer formation step, the ferromagnetic layer is formed inside the nanoholes in the porous layer.

### —Soft Magnetic Layer Formation Step—

The soft magnetic layer formation step is a step in which a soft magnetic layer is formed inside the nanoholes.

The soft magnetic layer can be formed, for example, by depositing or charging the material for the soft magnetic layer such as NiFe, FeSiAl, FeC, FeCoB, FeCoNiB, or CoZrNb, inside the nanoholes typically by electrodeposition.

The electrodeposition can be carried out according to any suitable procedure under any suitable conditions according to the purpose. It is preferably carried out by applying a voltage to a solution containing one or more of the materials for the soft magnetic layer using the soft magnetic underlayer or the electrode layer as an electrode and precipitating or depositing the material on the electrode.

As a result of the soft magnetic layer formation step, the soft magnetic layer is formed on or above the substrate, the soft magnetic underlayer or the electrode layer inside the nanoholes in the porous layer.

### —Nonmagnetic Layer Formation Step—

The nonmagnetic layer formation step is a step in which a nonmagnetic layer is formed on the soft magnetic layer.

The nonmagnetic layer can be formed, for example, by depositing or charging the material for nonmagnetic layer on the soft magnetic layer inside the nanoholes typically by electrodeposition.

The material for the nonmagnetic layer can be any suitable one selected from known materials such as Cu, Al, Cr, Pt, W, Nb, Ru, Ta and Ti. These materials can be used alone or in combination.

The electrodeposition can be carried out according to any suitable procedure under any suitable conditions according to the purpose. It is preferably carried out by applying a voltage to a solution containing one or more of the materials for the nonmagnetic layer using the soft magnetic underlayer or the electrode layer as an electrode and precipitating or depositing the material inside the nanoholes.

As a result of the nonmagnetic layer formation step, the nonmagnetic layer is formed on the soft magnetic layer or the like inside the nanoholes in the porous layer.

### —Polishing Step—

The polishing step is a step in which a surface of the porous layer is polished and flattened after the magnetic material charging step.

In the polishing step, the surface of nanohole structure can be polished according to any suitable known procedure. A suitable example thereof includes a CMP (Chemical Mechanical Polishing) process.

By flattening the surface of the magnetic recording medium in the polishing step, the magnetic head such as a vertical magnetic recording head can stably float to thereby realize high-density recording with good reliability.

Hereinafter, an example of a magnetic recording medium manufacturing method according to the present invention applied in the case where both sides of the substrate are used will be described with reference to the drawings.

In the same manner as described above, the mold 12 for A-side is used to produce the bonded article 16 composed of the substrate 15, aluminum layer 13, and soft magnetic underlayer 14 (and further a unillustrated metallic layer for increased mechanical strength) shown in FIG. 5 through the metallic layer formation step, substrate bonding step, and mold separation step shown in FIGS. 4A to 4D.

Meanwhile, as shown in FIGS. 6A to 6B, the mold 32 for B-side is used to previously produce, through the metallic layer formation step, a structure in which the aluminum layer 13 and soft magnetic underlayer 14 (and further a unillustrated metallic layer for increased mechanical strength) have been formed on the mold 32 for B-side.

Then, the surface of the substrate 15 of the bonded article shown in FIG. 5 on the side opposite to the bonding surface to the aluminum layer 13 is bonded to the outermost layer of the soft magnetic underlayer 14 (and further a unillustrated metallic layer for increased mechanical strength) formed on the aluminum layer 13 which has previously been formed on the mold 32 for B-side (see FIG. 7A).

Subsequently, the mold separation step is carried out to remove the mold 32 for B-side from the aluminum layer 13 formed on the mold 32 for B-side (see FIG. 7B).

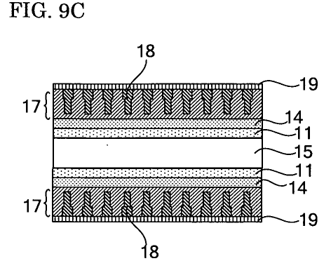

By applying the nanohole formation treatment (anodizing) to the aluminum layers 13 each having the concavo-convex pattern P2 formed on both the front and back sides of the substrate 15, a plurality of nanoholes 17A are formed in the direction substantially perpendicular to a plane of the substrate 15 using the concavo-convex pattern P2, whereby porous layers 17 are formed (porous layer formation step, see FIG. 9A).

Subsequently, in the magnetic material charging step, electrodeposition is carried out to charge a magnetic material 18 inside the nanoholes 17A (see FIG. 9B).

After the surfaces of the porous layers 17 in which the magnetic material 18 is charged inside the nanoholes 17A are flattened through the polishing step, protective films 19 are applied over the porous layers 17 followed by application of lubricant. As a result, a double-sided magnetic disk according to the present invention is obtained (see FIG. 9C).

The magnetic recording medium manufacturing method of the present invention is capable of providing a low cost, large capacity, and high density recording-enabled magnetic recording medium, achieving high pattern transfer accuracy, transferring a pattern that can serve as a source for forming anodized alumina-nanoholes with high precision, and realizing high productivity. Therefore, it is possible to manufacture a magnetic recording medium according to the present invention to be described below can be manufactured in an effective manner and at low cost.

### (Magnetic Recording Medium)

The magnetic recording medium according to the present invention includes a substrate and a porous layer on the substrate through an adhesive layer and may further include other layers selected according to necessity.

### —Substrate—

The substrate can have any suitable shape, structure and size and can be formed of any suitable material according to the purpose. The details thereof are as described above. Preferable examples of the substrate include a glass substrate, aluminum substrate, and silicon substrate.

### —Adhesive Layer—

The adhesive layer has a function of bonding the substrate and porous layer together.

The material of the adhesive layer is not particularly limited and may be suitably selected according to the purpose, but the abovementioned adhesive are preferably used. Specific examples thereof include epoxy resin-based adhesives, low-hardening contraction type adhesives, modified silicone resin-based adhesive, and cyanoacrylate adhesives.

### —Porous Layer—

The porous layer includes a plurality of nanoholes which are formed in the direction substantially perpendicular to the substrate surface. The details thereof are as described above.

The porous layer can have any suitable thickness according to the purpose. The thickness thereof is preferably 500 nm or less, and more preferably 5 nm to 200 nm.

If the thickness exceeds 500 nm, it may become difficult to charge the magnetic material into the nanoholes.

The nanoholes in the porous layer may be through holes penetrating the porous layer or be pits or concave portions not penetrating the porous layer. The nanoholes are preferably through holes penetrating the porous layer in consideration of a case where another magnetic layer is formed under the magnetic layer obtained by charging the magnetic material into the nanoholes.

The porous layer preferably has, at constant intervals, rows of nanoholes each including a plurality of nanoholes regularly spaced.

The interval between adjacent rows of nanoholes can be any suitable interval. When the nanohole structure is used in the magnetic recording medium such as a hard disk, the interval is preferably from 5 nm to 500 nm and more preferably from 10 nm to 200 nm.

If the interval is less than 5 nm, the nanoholes may be difficult to form. If it exceeds 500 nm, it may become difficult to arrange the nanoholes regularly.

The ratio (interval/width) of the interval between adjacent rows of nanoholes to the width of a row of nanoholes can be any suitable ratio and is preferably from 1.1 to 1.9 and more preferably from 1.2 to 1.8.

The ratio (interval/width) less than 1.1 may invite fused adjacent nanoholes and fail to provide separated nanoholes. A ratio exceeding 1.9 may invite formation of nanoholes in extra portions other than rows of groove portions in anodizing.

The rows of nanoholes can each have any suitable width according to the purpose. When the nanohole structure is used in the magnetic recording medium such as a hard disk, the width is preferably from 5 nm to 450 nm and more preferably from 8 nm to 200 nm.

If the rows of nanoholes have a width less than 5 nm, the nanoholes may be difficult to form. If it exceeds 450 nm, it may become difficult to arrange the nanoholes regularly.

The nanoholes are preferably arranged in one of a concentric manner and a helical manner when the substrate has a disk-shape. In particular, they are preferably arranged in a concentric manner in the use for hard disks in terms of accessibility, and are preferably arranged in a helical manner in the use for video disks because of advantage in continuous reproduction.

Further, the nanoholes in adjacent nanohole rows are preferably arranged in a radial direction. The resulting magnetic recording medium enables recording of information at high density and high speed with a large storage capacity without increasing a write current of the magnetic head, exhibits satisfactory and uniform properties such as overwrite properties, avoids crosstalk and crosswrite and is of very high quality.

The nanoholes can have openings with any suitable diameter according to the purpose. When the nanohole structure is used in the magnetic recording medium such as a hard disk, the diameter of opening is preferably such that the ferromagnetic layer becomes a single domain structure and is preferably 200 nm or less, and, more preferably, 5 nm to 100 nm.

If the nanoholes have openings with a diameter exceeding 200 nm, a hard disk having a single domain structure may not be obtained.

The nanoholes can have any suitable aspect ratio, i.e., a ratio of the depth to the diameter of opening, according to the purpose. A high aspect ratio is preferable for higher anisotropy in dimensions and for higher coercive force of the magnetic recording medium, and, for example, the aspect ratio is preferably 2 or more and more preferably 3 to 15.

An aspect of ratio less than 2 may lead to insufficient coercive force of the magnetic recording medium.

The nanoholes are preferably filled with a magnetic material to form a magnetic layer inside thereof.

The magnetic layer can be any suitable one according to the purpose and may be, for example, a ferromagnetic layer and a soft magnetic layer. In the present invention, it is sufficient to form at least the ferromagnetic layer inside the nanoholes. If necessary, the soft magnetic layer may be formed between the substrate and ferromagnetic layer. Further, if necessary, a nonmagnetic layer (interlayer) may be formed between the ferromagnetic layer and soft magnetic layer.

### —Ferromagnetic Layer—

The ferromagnetic layer functions as a recording layer in the magnetic recording medium.

The ferromagnetic layer can be formed from any known suitable material according to the purpose, such as Fe, Co, Ni, FeCo, FeNi, CoNi, CoNiP, FePt, CoPt and NiPt. These materials can be used singly or in combination.

The ferromagnetic layer can be any suitable layer formed from the material as a perpendicularly magnetized film. Suitable examples thereof are one having an Ll₀ ordered structure with the C axis oriented in a direction perpendicular to the substrate plane, and one having a fcc structure or bcc structure with the C axis oriented in a direction perpendicular to the substrate plane.

The ferromagnetic layer can have any suitable thickness that does not adversely affect the advantages of the present invention and can be set depending on, for example, the linear recording density. The thickness is preferably (1) equal to or less than the thickness of the soft magnetic layer; (2) one-thirds to three times the minimum bit length determined by the linear recording density used in the recording; or (3) equal to or less than the total thickness of the soft magnetic layer and the soft magnetic underlayer. It is generally preferably from about 5 nm to about 100 nm and, more preferably, from about 5 nm to 50 nm. It is preferably 50 nm or less (around 20 nm) in magnetic recording at a linear recording density of 1,500 kBPI at a target density of 1 Tb/in².

The thickness of the “ferromagnetic layer” means a total of the thickness of individual ferromagnetic layers when the ferromagnetic layer has plural continuous layers or plural separated layers, for example, in the case where the ferromagnetic layer is partitioned by one or more intermediate layers such as nonmagnetic layers and constitutes discontinuous separated ferromagnetic layers. The thickness of the “soft magnetic layer” means a total thickness of individual soft magnetic layers when the soft magnetic layer has plural continuous layers or plural separated layers, for example, in the case where the soft magnetic layer is partitioned by one or more intermediate layers such as nonmagnetic layers and constitutes discontinuous soft magnetic layers. The “total thickness of the soft magnetic layer and the soft magnetic underlayer” means a total of individual soft magnetic layers and soft magnetic underlayers when at least one of the soft magnetic layer and the soft magnetic underlayer has plural continuous layers or plural separated layers, for example, in the case where the soft magnetic layer or the soft magnetic underlayer is partitioned by one or more intermediate layers such as nonmagnetic layers and constitutes discontinuous soft magnetic (under) layers.

According to the magnetic recording medium of the present invention having the ferromagnetic layer and soft magnetic layer, the distance between a single pole head and the soft magnetic layer in magnetic recording can be less than the thickness of the porous layer and substantially equal to the thickness of the ferromagnetic layer. Thus, the convergence of a magnetic flux from the single pole head and the optimum properties for magnetic recording and reproduction at a recording density in practice can be controlled only by controlling the thickness of the ferromagnetic layer, regardless of the thickness of the porous layer. Consequently, the magnetic recording medium exhibits significantly increased write efficiency, requires a decreased write current and has markedly improved overwrite properties compared with conventional equivalents.

The ferromagnetic layer can be formed by means of any known suitable method such as electrodeposition.

### —Soft Magnetic Layer—

The soft magnetic layer can be formed from any known suitable material according to the purpose, such as NiFe, FeSiAl, FeC, FeCoB, FeCoNiB and CoZrNb. These materials can be used singly or in combination.

The soft magnetic layer can have any suitable thickness that does not adversely affect the advantages of the present invention and is selected according to the depth of nanoholes in the porous layer and the thickness of the ferromagnetic layer. For example, (1) the soft magnetic layer has a thickness greater the thickness of the ferromagnetic layer, or (2) the total thickness of the soft magnetic layer and the soft magnetic underlayer may be greater than the thickness of the ferromagnetic layer.

The soft magnetic layer advantageously serves to effectively converge a magnetic flux from the magnetic head in magnetic recording to the ferromagnetic layer to thereby increase the vertical component of magnetic field of the magnetic head. The soft magnetic layer and the soft magnetic underlayer preferably constitute a magnetic circuit of a recording magnetic field supplied from the magnetic head.

The soft magnetic layer preferably has an axis of easy magnetization in a direction substantially perpendicular to the substrate plane. Thus, in magnetic recording using a vertical magnetic recording head, the convergence of a magnetic flux from the vertical magnetic recording head and the optimum properties for magnetic recording and reproduction at a recording density in practice can be controlled and the magnetic flux converges to the ferromagnetic layer. As a result, the magnetic recording medium exhibits significantly increased write efficiency, requires a decreased write current and has markedly improved overwrite properties compared with conventional equivalents.

The soft magnetic layer can be formed by any known suitable method such as electrodeposition.

### —Non-Magnetic Layer—

The nanoholes in the porous layer may further include a nonmagnetic layer (interlayer) between the ferromagnetic layer and the soft magnetic layer. The nonmagnetic layer (interlayer) works to reduce the action of an exchange coupling force between the ferromagnetic layer and the soft magnetic layer to thereby control and adjust the reproduction properties in magnetic recording at desired levels.

The material for the nonmagnetic layer can be any suitable one selected from known materials such as Cu, Al, Cr, Pt, W, Nb, Ru, Ta and Ti. These materials can be used singly or in combination.

The nonmagnetic layer can have any suitable thickness according to the purpose.

The nonmagnetic layer can be formed by any known suitable method such as electrodeposition.

### —Soft Magnetic Layer—

The magnetic recording medium may further have a soft magnetic underlayer between the substrate and porous layer.

The soft magnetic underlayer can be formed from any suitable material heretofore known such as those exemplified as the materials for the soft magnetic layer. These materials can be used singly or in combination. The material for the soft magnetic underlayer can be the same as or different from that for the soft magnetic layer.

The soft magnetic underlayer preferably has its axis of easy magnetization in an in-plane direction of the substrate. Thus, a magnetic flux from the magnetic head for recording effectively closes to form a magnetic circuit to thereby increase the vertical component of the magnetic field of the magnetic head. The use of the soft magnetic underlayer is also effective in recording in single domain at a bit size (diameter of opening of the nanoholes) of 100 nm or less.

The soft magnetic underlayer can be formed by any known suitable method such as electrodeposition or electroless plating.

### —Other Layers—

The magnetic recording medium may further have one or more other layers according to the purpose, such as an electrode layer and protective layer.

The electrode layer works as an electrode during the formation of the magnetic layer (including the ferromagnetic layer and soft magnetic layer) by electrodeposition and is generally arranged on the substrate and below the ferromagnetic layer. To form the magnetic layer by electrodeposition, the electrode layer as well as the soft magnetic underlayer or another layer can be used as the electrode.

The electrode layer can be formed from any suitable material according to the purpose, such as Cr, Co, Pt, Cu, Ir, Rh, and alloys thereof. These can be used singly or in combination. The electrode layer may further contain any of other substances such as W, Nb, Ti, Ta, Si and O in addition to the aforementioned materials.

The electrode layer can have any suitable thickness according to the purpose. The magnetic recording medium may have one or more of such electrode layers.

The electrode layer can be formed according to any known suitable procedure such as sputtering or vapor deposition.

The protective layer works to protect the ferromagnetic layer and is arranged on or above the ferromagnetic layer. The magnetic recording medium may have one or more of such protective layers which have a single-layer structure or multilayer structure.

The protective layer can be formed from any suitable material according to the purpose, such as diamond-like carbon (DLC).

The protective layer can have any suitable thickness according to the purpose.

The protective layer can be formed by any known suitable method, such as sputtering, plasma CVD or coating.

The magnetic recording medium according to the present invention can be used in various magnetic recording systems using a magnetic head, and can favorably be used in magnetic recording using a single pole head.

The magnetic recording medium according to the present invention enables recording of information at high density and high speed with a large storage capacity and is of very high quality. Thus, the magnetic recording medium can be designed and used as a variety of magnetic recording media. For example, the magnetic recording medium can be designed and used as a hard disk drive widely used in external storage device for a computer and house-hold video recorders and can particularly suitably be designed and used as a magnetic disk such as a hard disk.

### EXAMPLES

Examples of the present invention will hereinafter be described. It is however to be noted that these Examples are merely illustrative purpose only and shall not be construed as limiting the present invention.

### —Transfer Experiment of Pattern in Mold to Aluminum Layer (1)—

### <Metallic Layer Formation Step>

Ni molds N1 and N2 having the same shape as a glass substrate for 1 inch HDD were prepared. The Ni mold Ni has, on its surface, a concentrically formed land/groove pattern (concavo-convex pattern) with a pitch of 90 nm, and N1 mold N2 has, on its surface, a concentrically formed land/groove pattern (concavo-convex pattern) with a pitch of 150 nm. The height of the land portions in the concavo-convex pattern was set to about 50 nm in both the Ni molds N1 and N2.

The Ni mold Ni (or N2) was bonded and fixed to a base made of SUS and then immersed in a releasing agent (“Novec EGC-1720” manufactured by Sumitomo 3M Ltd.) by a dip method, followed by withdrawal from the releasing agent at a speed of about 3 mm/s to 4 mm/s, whereby the coating of the releasing agent on the concavo-convex pattern in the Ni mold Ni (N2) was completed. Subsequently, the resultant Ni mold Ni (N2) was dried and heated at 100° C. for 30 minutes, followed by cooling to room temperature.

Then, the Ni mold Ni (N2) was set in a DC magnetron sputtering apparatus and subjected sputtering for 120 minutes using a 99.99% pure Al target at an Ar gas pressure of 0.3 Pa at an input power of 50 W to thereby form an aluminum layer having a thickness of 5 μm on the respective concavo-convex patterns of the Ni molds N1 and N2.

### <Substrate Bonding Step>

An adhesive (Bond-white for repairing enameled products” manufactured by Konishi Co., Ltd.), was applied to the surfaces of the obtained aluminum layers on the side opposite to the Ni molds N1 and N2, i.e., the sputtered surfaces of the Aluminum layers, and then glass substrates for 1 inch HDD were bonded to the respective aluminum layers. After curing of the adhesive, portions of the adhesive protruding out from the glass substrates were removed using a knife.

### <Mold Separation Step>

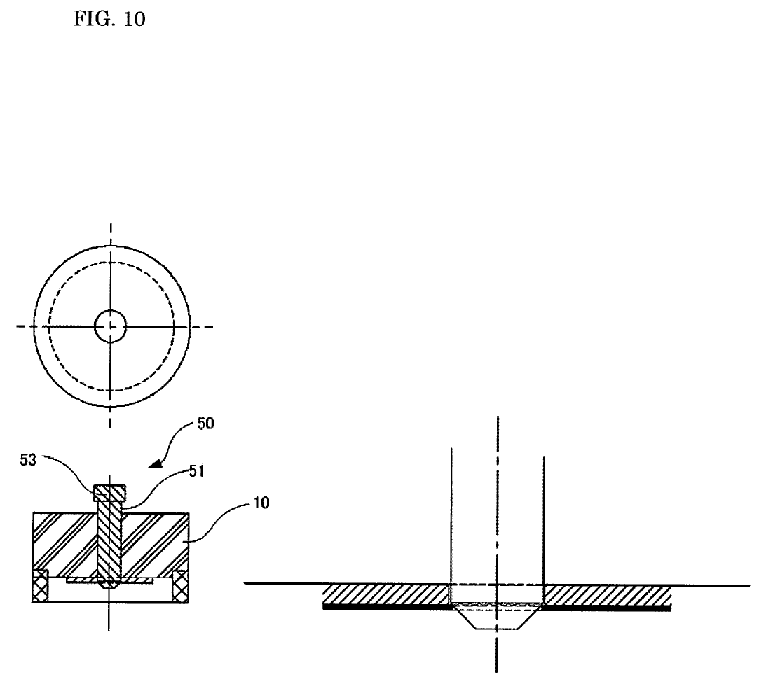

A separation tool having a push-up mechanism, which is as shown in FIG. 10, was experimentally produced in order to separate the mold from the aluminum layer.

The separation tool shown in FIG. 10 is constituted by a push-up mechanism 50 having the same configuration as that of the push-up mechanism 20 of FIG. 3A. The push-up mechanism 50 includes a push-up pin 51 for contacting an inner peripheral edge 15A of a glass substrate 15 (glass substrate for HDD) having an opening in the center thereof to push up the glass substrate 15, a unillustrated spring, and a pressure pin 53 for pushing up the push-up pin 51. In this configuration, the push-up pin 51 is biased toward the pressure pin 53 by the spring. The push-up pin 51 and pressure pin 53 are made of SUS 303.

The pressure pin 53 of the separation tool was pressed. Then, in the same manner as the push-up mechanism 20 described above (FIG. 3B), the leading end of the push-up pin 51 biased, by the unillustrated spring, toward the pressure pin 53 was brought into contact with the inner peripheral surface 15A of the glass substrate (glass substrate for HDD) having an opening in the center thereof to push up the glass substrate 15 from the mold 12 side, whereby the mold 12 was separated from the aluminum layer 13. As a result, the concavo-convex pattern P1 was transferred onto the surface of the aluminum layer 13, whereby a concavo-convex pattern P2 in which a plurality of groove portions (concave lines) and plurality of land portions (convex lines) are alternately arranged was formed on the surface of the aluminum layer 13. The concavo-convex pattern obtained from the Ni mold Ni had a groove/land pitch of 90 nm; while the concavo-convex pattern obtained from the N1 mold N2 had a groove/land pitch of 150 nm. The depth of the groove portions was about 50 nm in both the concavo-convex patterns of the aluminum layers 13.

Wrinkles did not appear on the surface of the aluminum layer after the substrate separation step, as shown in FIGS. 2A and 2B.

### <Porous Layer Formation Step>

Anodizing was applied to the aluminum layer 13 having, on its surface, the concavo-convex pattern P2 to form a plurality of nanoholes, thereby obtaining a porous layer shown in FIG. 9A.

The anodizing was carried out at an anodizing voltage of 40 V using 0.3 ML oxalic acid as anodizing solution at a bath temperature of 16° C. Further, current recovery was made in order to charging a magnetic material (Co) into the nanoholes by plating. The pitch of nanoholes can be represented by the following expression (1).

$$Nanohole pitch ( nm ) = anodizing voltage ( V ) \times 2.5 \qquad Expression ( 1 )$$

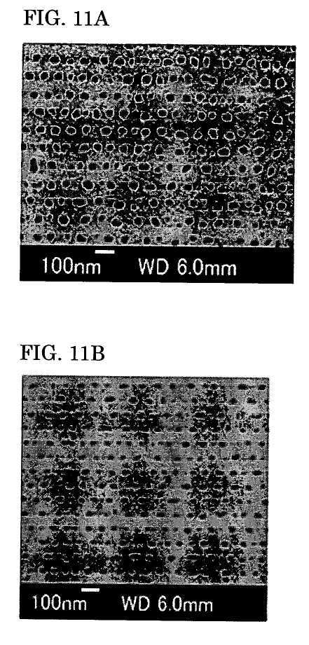

An observation was made for the nanohole pattern in the fine pore array (porous layer) obtained by the anodizing using a scanning electron microscope (SEM). As a result, a nanohole array as shown in FIGS. 11A and 11B was recognized.

As shown in FIG. 11A, in the case where the concavo-convex pattern having a groove/land pitch of 90 nm is used as the nanohole source, the nanohole were arranged in one row on the groove portion (concave line) under the above anodizing condition.

Further, as shown in FIG. 11B, in the case where the concavo-convex pattern having a groove/land pitch of 150 nm is used as the nanohole source, the nanoholes were arranged in two rows on the groove portion (concave line) under the above anodizing condition, as described in JP-A No. 2007-210086.

It was confirmed from the above results that by using, as the nanohole source, the concavo-convex pattern which has been obtained by precisely transferring the land/grove pattern (concavo-convex pattern) in the Ni mold to the aluminum layer, the nanoholes can be formed as expected.

### —Transfer Experiment of Pattern in Mold to Aluminum Layer (2)—

Ni mold was immersed in 0.1 wt % solution of silane coupling agent (“Optool DSX” manufactured by Daikin Industries Ltd.) in place of the releasing agent (“Novec EGC-1720” manufactured by Sumitomo 3M Ltd.) used in the metallic layer formation step in the transfer experiment (1), followed by drying the coating for about 3 hours. Subsequent substrate bonding step, mold separation step, and porous layer formation step were carried out in the same manner as the transfer experiment (1).

As a result, in the mold separation step, the mold was satisfactorily separated by means of the push-up mechanism from the aluminum layer without occurrence of wrinkles, and the land/groove pattern (concavo-convex pattern) in the Ni mold was precisely transferred onto the aluminum layer, whereby a concavo-convex pattern was formed on the aluminum layer. Further, in the porous layer formation step, it was confirmed that the nanoholes can be formed as expected by using the obtained concavo-convex pattern as the nanohole source.

### —Transfer Experiment of Pattern in Mold to Aluminum Layer (3)—

The metallic layer formation step and substrate bonding step were carried out in the same manner as in the transfer experiment (1), and the mold separation step was carried out in the following manner to remove the mold from the aluminum layer.

### <Mold Separation Step>

A knife edge was inserted between the glass substrate for HDD and Ni mold to separate the glass substrate from the Ni mold. Although this separation step was carried out four or five times, wrinkles occurred on the surface of the aluminum layer as shown in FIGS. 1A and 1B. Thus, it was confirmed that it is difficult to remove the glass substrate from the Ni mold without occurrence of wrinkles, as compared to the separation step using the push-up mechanism in the transfer experiment (1).

### Example 1

### Manufacturing of Magnet Recording Medium

The pattern in the Ni mold was transferred onto the aluminum layer in the same manner as in the transfer experiment (1) to manufacture a double-sided magnetic recording medium.

### <Metallic Layer Formation Step>

As in the case of the transfer experiment (1), a Ni mold Ni for A-side having the same shape as a glass substrate for 1 inch HDD was prepared. The Ni mold Ni has, on its surface, a concentrically formed land/groove pattern (concavo-convex pattern) with a pitch of 90 nm. The height of the land portions in the concavo-convex pattern was set to about 50 nm.

The Ni mold Ni was bonded and fixed to a base made of SUS and then immersed in a releasing agent (“Novec EGC-1720” manufactured by Sumitomo 3M Ltd.) by dipping, followed by withdrawal from the releasing agent at a speed of about 3 mm/s to 4 mm/s, whereby application of the releasing agent over the concavo-convex pattern in the Ni mold Ni was completed. Subsequently, the resultant Ni mold Ni was dried and heated at 100° C. for 30 minutes, followed by cooling to room temperature.

Then, the Ni mold Ni was placed in a DC magnetron sputtering apparatus and sputtering was conducted under the same condition as in the transfer experiment (1) to thereby deposit an aluminum layer having a thickness of 300 nm on the concavo-concave patterns of the Ni mold Ni.

### <Soft Magnetic Underlayer Formation Step>

A CoZrNb/Ru/CoZrNb film is formed, as so-called an APS-SUL (Anti-Parallel Structure-Soft Magnetic Underlayer) on the obtained aluminum layer.

Further, a Ta film is so formed, as a metallic layer for mechanical strength to have a 1 μm thickness.

### <Substrate Bonding Step and Mold Separation Step>

After the substrate bonding step was carried out in the same manner as the transfer experiment (1), the mold separation step was carried out using the push-up mechanism to remove the Ni mold (for A-side) from the aluminum layer, thereby obtaining a bonded article 16 composed of the glass substrate for HDD, aluminum layer, and soft magnetic underlayer (and further a unillustrated metallic layer for increased mechanical strength).

Meanwhile, as in the case of the metallic layer formation step and soft magnetic underlayer formation step, a Ni mold 32 (for B-side) having the same shape as the Ni mold (for A-side) was used to obtain a laminated structure in which an aluminum layer 13 and soft magnetic underlayer 14 (and further a unillustrated metallic layer for increased mechanical strength) are laminated in this order, as shown in FIGS. 6A and 6B.

Then, the surface of the substrate 15 of the bonded article 16 shown in FIG. 5 on the side opposite to the bonding surface to the aluminum layer (A-side) was bonded to the outermost layer of the soft magnetic underlayer 14 shown in FIG. 6B (and further a unillustrated metallic layer for increased mechanical strength) formed on the aluminum layer 13 (B-side) which has previously formed on the Ni mold 32 (for B-side) (see FIG. 7A).

Subsequently, the mold separation step was carried out using the push-up mechanism to remove the Ni mold 32 (for B-side) from the aluminum layer 13 (B-side) (see FIG. 7B).

### <Porous Layer Formation Step>

Anodizing was applied to the respective aluminum layers 13 (A-side and B-side) having on the surfaces thereof the concavo-convex patterns under the same condition as in the transfer experiment (1) to form a plurality of nanoholes 17A, thus obtaining a porous layer 17 as shown in FIG. 9A.

### <Magnetic Material Charging Step>

Electrolytic deposition was carried out in an electrolyte containing 50 g/l of cobalt sulfate heptahydrate and 20 g/l of boracic acid at 50 Hz and at 10 V for 10 minutes to charge cobalt (Co) serving as a magnetic material 18 into the nanoholes to thereby form a ferromagnetic layer in the nanoholes 17A.

### <Polishing Step>

After the magnetic material charging step, the surface polishing was applied to the porous layer by flattening the cobalt (Co) protruded out from the nanoholes by CMP (see FIG. 9B). After the polishing step, the porous layer (alumina layer) had a thickness of about 250 nm and the nanoholes (alumina pores) filled with the cobalt (Co) had an aspect ratio of about 7.

After that, as shown in FIG. 9C, a film of carbon was so formed to have a 5 nm thickness to obtain a protective layer 19 by RF sputtering. Further, perfluoroalkylpolyether (“AM3001” manufactured by Solvay Solexis) was applied as lubricant by dipping to thereby form a magnetic recording medium (magnetic disk sample for characteristic evaluation). In the obtained magnetic recording medium, the porous layer 17 was formed on the substrate 15 with the adhesive layer 11 interposed between them.

### —Magnetic Recording Medium Characteristic Evaluation—

Characterization of the obtained magnetic disk sample was conducted as follows.

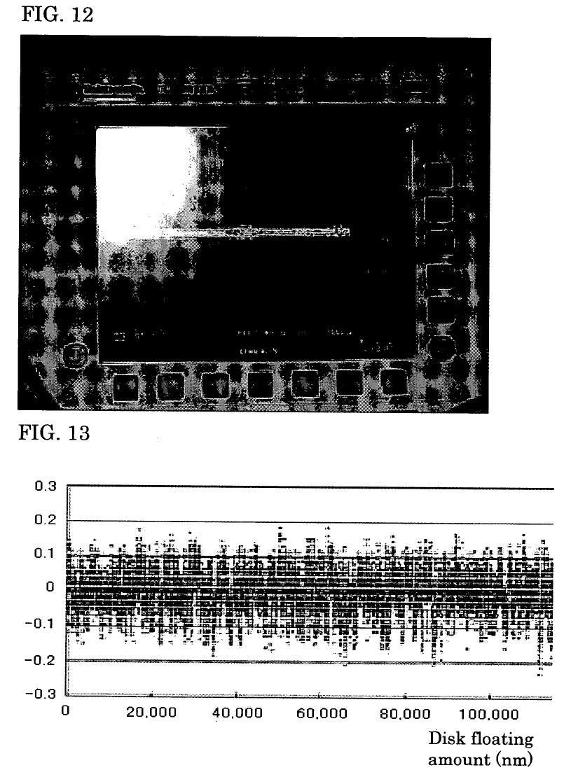

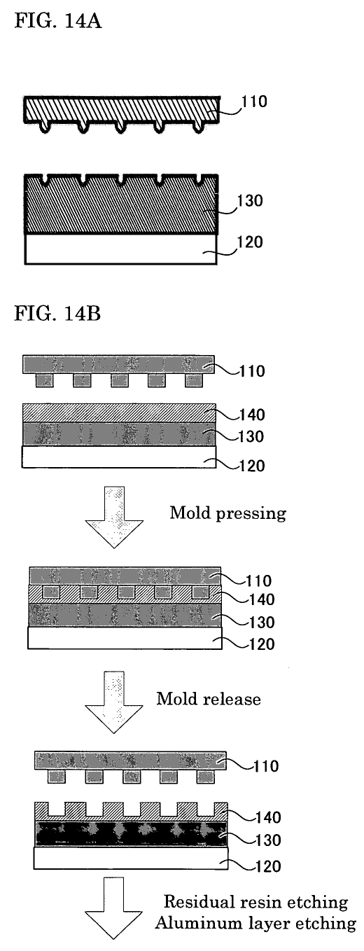

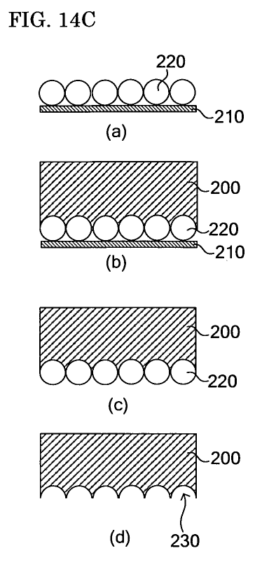

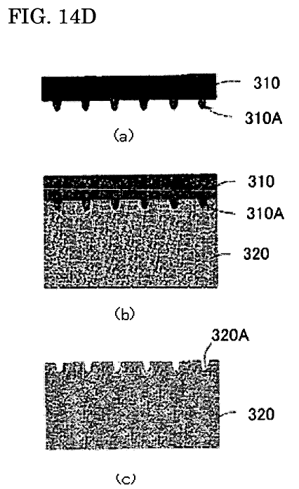

FIG. 12 shows a piezo output waveform obtained in the case where a piezo head, which floats by 60 nm while rotating a magnetic disk at a peripheral speed of 8 m/s under normal circumstances, floated away from the disk sample for characteristic evaluation while rotating the disk sample at a peripheral speed of 6 m/s. As can be confirmed from FIG. 12, the head floated.

Subsequently, the magnetic head was allowed to move up while rotating the disk sample for characteristic evaluation to record a magnetic signal of 400 nm frequency, and reproduction of the magnetic signal was performed. The obtained reproduction waveform is shown in FIG. 13. As can be confirmed from FIG. 13, the disk sample for characteristic evaluation satisfactorily functioned as a magnetic disk.

According to the present invention, it is possible to solve the problems inherent to related arts and to provide a low cost manufacturing method of a magnetic recording medium capable of transferring a pattern that can serve as a source for forming anodized alumina-nanoholes with high precision and realizing high productivity, and a large-capacity magnetic recording medium which is suitably used in a hard disk drive widely used as an external storage device for a computer, a household video recording device, and the like and which is capable of achieving high density recording.

The magnetic recording medium according to the present invention can suitably be used in a hard disk drive widely used as an external storage device for a computer, a household video recording device, and the like.

The magnetic recording medium manufacturing method according to the present invention can manufacture a large capacity magnetic recording medium capable of achieving high density recording with high productivity and at low cost and can particularly suitably be applied to the manufacturing of the magnetic recording medium according to the present invention.

What is claimed is:

1. A method for manufacturing a magnetic recording medium, comprising:
forming a metallic layer on a concavo-convex pattern formed on a surface of a mold;
bonding a substrate using an adhesive to a surface of the metallic layer on the side opposite to the mold;
separating the mold from the metallic layer;
forming, through nanohole formation treatment, a porous layer in which a plurality of nanoholes are formed to orient in a direction substantially perpendicular to a substrate plane by using as a nanohole source a concavo-convex pattern which has been formed by transferring the concavo-convex pattern in the mold to the metallic layer; and
charging a magnetic material inside the nanoholes.

2. The method according to claim 1, wherein the concavo-convex pattern in the mold has land portions and groove portions which are alternately arranged.

3. The method according to claim 1, wherein the metallic layer is made of aluminum.

4. The method according to claim 1, further comprising forming a soft magnetic underlayer over the metallic layer.

5. The method according to claim 1, wherein the substrate is at least one of a glass substrate, aluminum substrate, and silicon substrate.

6. The method according to claim 1, wherein the step of forming the metallic layer includes applying a releasing agent over the concavo-convex pattern in the mold before the formation of the metallic layer.

7. The method according to claim 1, wherein the releasing agent is at least one of a fluorine-containing surface treating agent and a silane coupling agent.

8. The method according to claim 1, wherein the adhesive is at least one of an epoxy resin-based adhesive, a low-hardening contraction type adhesive, a modified silicone resin-based adhesive, and a cyanoacrylate adhesive.

9. The method according to claim 1, wherein the step of separating the mold is carried out by pushing up from the mold side an inner peripheral edge of the substrate having an opening in the center thereof by means of a push-up mechanism.

10. The method according to claim 1, further comprising bonding a second metallic layer to a surface of the substrate on the side opposite to the bonding surface to the metallic layer and separating the mold from the second metallic layer, before the step of forming the porous layer and after the step of separating the mold, the second metallic layer being previously formed on a mold by the step of forming the metallic layer.

11. The method according to claim 1, wherein the steps of forming the metallic layer, bonding the substrate, and separating the mold are collectively carried out for a plurality of substrates.

12. The method according to claim 1, further comprising, polishing the surface of the porous layer after the step of charging the magnetic material.

13. A magnetic recording medium comprising:
a substrate;
an adhesive layer over the substrate; and
a porous layer over the adhesive layer,
wherein the porous layer comprises a plurality of nanoholes that are oriented in a direction substantially perpendicular to a plane of the substrate, and
wherein the nanoholes comprise therein a magnetic material.
